(19) United States
(12) Patent Application Publication
(10) Pub. No.: US 2008/0001484 A1
(43) Pub. Date: Jan. 3, 2008

(54) Linear Electromechanical Vibrator with Axially Movable Magnet

(76) Inventors: Chris Fuller, Virginia Beach, VA (US); Steve Booth, Blacksburg, VA (US); George Osborne, Fairview Park (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/428,460

(22) Filed: Jul. 3, 2006

(51) Int. Cl. H02K 33/00; H02K 35/00

(52) U.S. Cl. 310/15

(57) ABSTRACT

An electromagnetic vibrator has a movable magnet that can move linearly in an axial direction. A field coil surrounds the movable magnet. Magnetic bumpers are disposed on opposite ends of the vibrator, and are oriented to repel the movable magnet. When an alternating current is provided in the field coil, the movable magnet oscillates linearly in the axial direction, bumping against the magnetic field of the bumper magnets and thereby creating vibration. The movable magnet may have a toroidal shape and be disposed on an axial shaft to linearly constrain the motion of the movable magnet. Two field coils can be provided to simultaneously create push and pull forces on the movable magnet. The bumper magnets can be replaced with compression springs. The electromagnetic vibrator can be very small and energy efficient; it is well suited for use in portable electronic devices, cell phones, toys, industrial mixers, and massage devices.

### FIELD OF THE INVENTION

The present invention relates generally to linear electromagnetic vibrators, and, more particularly, to a non-rotary electromagnetic vibrator having a movable magnet that oscillates axially under the influence of an axial field coil.

### BACKGROUND OF THE INVENTION

Electromagnetic shakers and vibrators are commonly used in cellular telephones and other portable electronic devices. Such vibrators are activated in order to silently alert a user of an incoming message.

Conventional cell phone vibrators typically have a miniature rotary motor with an eccentric mass attached to the rotor. The eccentric mass produces oscillating acceleration forces when the motor is activated. Such rotary vibrators are relatively expensive and complicated to manufacture because the motor requires assembly of many small parts. Also, rotary vibrators tend to be energy inefficient. In portable electronic devices such as cell phones, energy efficiency is critical.

Accordingly, there is a need for an inexpensive, simple and energy efficient miniature vibrator. Such a vibrator could be widely used in portable electronic devices such as cell phones. Also, such a vibrator could be scaled up in size and widely used in other applications such as in personal massage devices, industrial shaking or mixing devices and the like.

### SUMMARY

The present invention provides an electromagnetic vibrator having a movable magnet. The magnet moves in an axial direction (linearly or along a curved path). The movable magnet is magnetized in the axial direction. Two bumper magnets are disposed axially in-line with the movable magnet. The bumper magnets are oriented such that they magnetically repel the movable magnet. In operation, the movable magnet is not always required to “bump” up against the bumper magnets (although this may be beneficial in some applications); rather, movement of the movable magnet in a first direction under the influence of an externally applied electric field followed by a repelling force of a bumper magnet at the end of the pathway for travel results in a “vibration” that emanates from the housing in which the moveable magnet is located, This process is repeated at the other end of the pathway traveled by the moveable magnet. That is, the mass of the moveable magnet, and its oscillatory movement from one end to another along an axial pathway results in vibrations being transmitted from the housing or other support to an external environment. The vibrator can be small in size (e.g., prototypes the size of a quarter have been prepared and tested, but smaller sizes would be possible), and may be used in a variety of different electronic devices such as providing a “silent ringer” vibration in a cell phone or other communicating device, providing a vibratory sensation in a toy or massaging device, etc. Also, the vibrator can be used for mixing in laboratory or industrial applications. The vibrator may be used in combination with other vibrators in an array. Virtually any application where a vibrator is required can be fulfilled by this invention. In addition, the vibrator described herein has the advantage of being simple to construct, does not require a large number of parts, and does not require significant amounts of power to operate. The vibrator can also accurately replay a drive signal time history similar to a loud speaker in contrast to a rotating eccentric mass vibrator which can only modulate its speed of rotation.

In its simplest construction, the movable magnet is disposed between the bumper magnets and travels along a linear or curved axial pathway. The vibrator has at least one field coil for causing the movable magnet to move in the axial direction. When excited by the field coil, the movable magnet will oscillate between the bumper magnets and create vibrations.

The bumper magnets can be replaced with mechanical compression springs or electromagnetic bumper coils. The bumper coils can be activated to repel the movable magnet each time the moveable magnet approaches.

The movable magnet can have a toroidal shape, with a hole in the center. Also, the vibrator can have an axial shaft. The axial shaft can extend through the hole in the toroidal movable magnet. The axial shaft can extend the full length of the vibrator, and can be straight or curved.

The movable magnet can be disposed within a hollow enclosure (e.g. having a cylindrical shape). The bumper magnets can be disposed at opposite ends of the enclosure. The enclosure can have one or more air holes to allow air to enter and escape as the movable magnet oscillates.

Also, the bumper magnets can have air vents to allow air to enter and escape as the movable magnet oscillates.

The vibrator can have two spaced apart field coils to excite the movable magnet. The field coils can be operated to apply both push and pull forces to the movable magnet.

Also, a pickup coil can be disposed between the field coils. The pickup coil can be used in a feedback circuit to resonantly control the motion of the movable magnet.

The stiffness and thus resonance of the vibratory actuator of this invention can by adjusted by changing either the magnetic strength of the bumper magnets at the end of the pathway traveled by the moveable magnet, or by changing the size of the air vents in either the housing or end caps (i.e., large venting of air (or other fluid ) within the housing provides for higher resonance, while smaller venting results in lower resonance). In some applications, it may be desirable to allow for adjusting the strength of the bumper magnets (e.g., by using electronmagnets as the bumper magnets and by permitting adjustment of the electric power to the electromagnets) or to allow for adjusting the air venting (e.g., by providing a valve mechanism that can be mechanically or electronically controlled) so that the resonance can be set to levels preferred by a user (e.g., the user sets the degree of vibration provided by his cell phone) or which are optimized for a particular application (e.g., different levels of vibration may be preferred for viscous fluids and non-viscous fluids).

### DESCRIPTION OF THE FIGURES

FIG. 1 shows a perspective view of an electromechanical vibrator.

FIG. 2 shows a cross sectional view of an electromechanical vibrator.

FIG. 3 shows a cross sectional view of an embodiment that does not have an axial shaft 22.

FIG. 3a is an end view of the movable magnet shown in FIG. 3.

FIG. 4 shows a cross sectional view of an embodiment having a single field coil.

FIG. 5 shows a cross sectional view of an embodiment having bumper coils.

FIG. 6 shows a cross sectional view of an embodiment having field coils disposed at axial ends of the vibrator.

FIG. 7 shows a cross sectional view of an embodiment having a hollow axial shaft.

FIG. 8 shows a cross sectional view of an embodiment having mechanical bumper springs attached to end caps of the vibrator.

FIG. 9 shows a cross sectional view of an embodiment having mechanical bumper springs attached to the movable magnet.

FIG. 10 shows a cross sectional view of an embodiment with a curved shape.

### DETAILED DESCRIPTION

The present invention provides an electromagnetic vibrator particularly well suited for use in portable electronic devices such as cell phones, toys, games, personal massage devices and the like. The electromagnetic vibrator has a movable magnet that can move in an axial direction. One or more electromagnetic field coils surround the movable magnet. Bumper magnets are disposed on opposite ends of the vibrator, and constrain the axial motion of the movable magnet. When an alternating current is provided in the field coil, the movable magnet oscillates linearly in the axial direction. The movable magnet rebounds from the bumper magnets, thereby creating vibration. This rebounding can be with or without actual touching of the bumper magnets which are poled to repel the oncoming moveable magnet. The movable magnet may have a toroidal shape (other shapes being possible in different applications) and may be disposed on a straight rod to linearly constrain the motion of the movable magnet. The bumper magnets can be replaced with electromagnetic bumper coils or mechanical coil springs.

The present vibrator is capable of reproducing complex applied electrical signals and frequencies, and so can reproduce sound and function as a loudspeaker. In contrast, conventional rotary-eccentric mass vibrators can only modulate the output frequency by varying the rotational speed of the eccentric mass. Also, the current vibrator is simpler in construction than rotary vibrators.

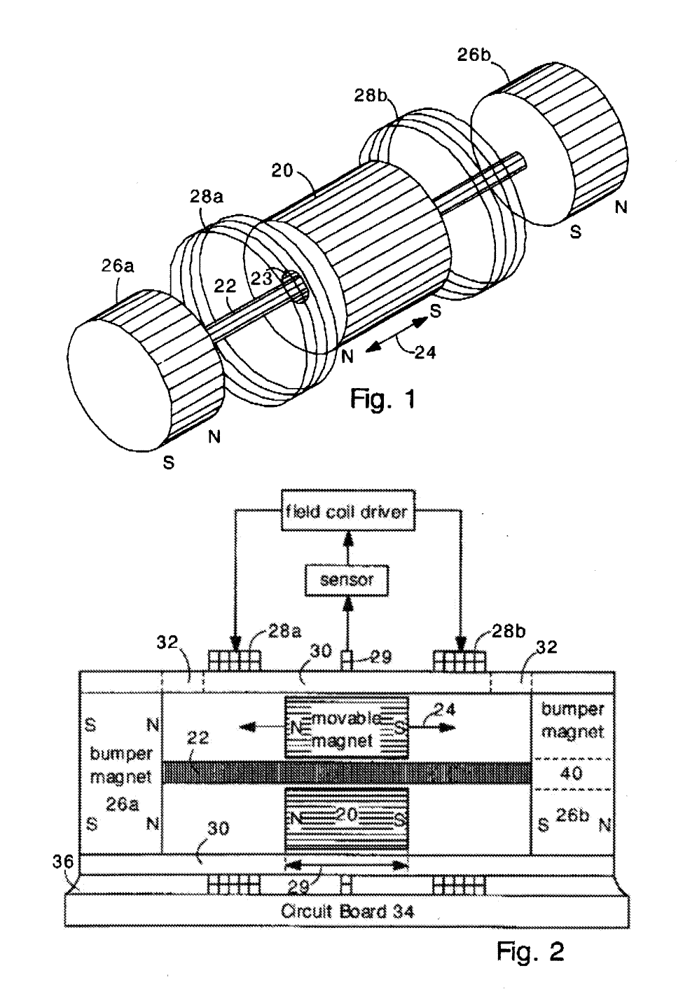

FIG. 1 shows a perspective view of an electromagnetic vibrator according to the present invention. For clarity, an optional tubular enclosure is omitted from FIG. 1 and only the main functional components are illustrated. The electromagnetic vibrator has a toroidal movable magnet 20 disposed on an axial shaft 22. The axial shaft 22 extends through a central hole 23 in the movable magnet 20. The movable magnet is free to slide in an axial direction 24. Field coils 28a 28b wrap around the vibrator device. The field coils 28 have an inner diameter that is large enough to accommodate the movable magnet 20. Bumper magnets 26a 26b are fixedly disposed at opposite ends of the axial shaft 22. The bumper magnets 26 are fixed in place and are not free to slide on the shaft 22. All the magnets are magnetized in the axial direction (i.e. parallel with the shaft 22). The bumper magnets 26 are oriented such that they magnetically repel the movable magnet 20 (i.e., they are oppositely poled to the end surface of the moveable magnet which is closest to the bumper magnet 26a or 26b); orientation of the magnets 20 26 is shown by the N and S indicia.

FIG. 2 shows a schematic cross sectional view of the vibrator device. FIG. 2 includes the optional tubular hollow enclosure 30. The enclosure can be cylindrical as illustrated, or can be square or can have other cross sectional shape. Preferably, the enclosure 30 is made of a lightweight polymeric material such as polycarbonate. Also preferably, the tubular enclosure has at least one air hole 32 for allowing air to escape and enter the enclosure as the movable magnet 20 oscillates. The enclosure 30 can be perforated with many holes. The air holes 32 reduce viscous friction losses that would otherwise cause damping of the magnet motion. However, in some applications, a valve, e.g., a plate which covers a portion of the air holes 32, may be provided to regulate the resonance of the vibrator wherein higher resonance is achieved with more open air holes and lower resonance is achieved with air holes being partially closed. Further, in some applications the movable magnet will travel along the axial path in a fluid other than air where the fluid fills the housing 30.

In addition to the air holes 32 or as an alternative, the bumper magnets 26 can have air vents 40 to allow air to escape and enter the enclosure as the movable magnet 20 oscillates. These air vents 40 could also be equipped with a valve mechanism for controlling vibratory resonance. Also the movable magnet can have air vents in its body or at its side to let air pass from one side of the moveable magnet to the other has it vibrates.

The total axial length of the vibrator can be about ¼ inch to 1 inch, 2 inches, 10 inches or larger. Preferably, the magnets 20 26 are high strength rare earth magnets, but the magnets can be made of any magnetic material or magnetizable material. The shaft 22 is preferably made of a nonferrous metal or plastic. The shaft 22 can have a solid cylindrical construction, or can have an I-beam, hollow tubular, or cross (i.e. +) shape. Also, the vibrator can have multiple shafts positioned in parallel.

The field coils 28 can comprise conventional copper wire windings; however, other metal or metal alloy windings may be employed. Preferably, two coaxial field coils 28 are spaced apart, as illustrated in FIGS. 1 and 2. Preferably, the field coils 28 are spaced apart by a distance at least as great as an axial length 29 of the movable magnet 20. The field coils can be connected in series or parallel. If the field coils are connected in series, then they should be wound in opposite directions so that they produce anti-parallel magnetic fields.

A low viscosity lubricant such as silicone oil can be provided on the shaft 22 to minimize friction between the movable magnet 20 and the shaft 22. Ferrofluid adhered to the movable magnet 20 can also be used to reduce friction. Alternatively, small ball bearings or graphite particles can be used to reduce friction.

The vibrator can have a pickup coil 29 for monitoring the position of the movable magnet 20. Electrical signals induced in the pickup coil by the movable magnet 20 are detected by a sensor circuit and used to control the operation of a field coil driver circuit. The field coil driver circuit can be a conventional amplifier circuit or switching circuit or the like.

The vibrator can be attached to a circuit board 34 or other support with adhesive 36, as illustrated in FIG. 2. Also, fasteners such as bolts or screws can be used.

In operation, an alternating current is provided in the field coils 28a 28b. Preferably, the field coils 28 are oriented such that they apply push and pull forces to the movable magnet 20. In order to provide push and pull forces, the field coils 28 must have anti-parallel magnetic fields (e.g. field coils can be wound in opposite directions, as noted above). As the movable magnet 20 oscillates under the influence of the field coils 28, it repeatedly rebounds from the magnetic field of the bumper magnets 26. The movable magnet will oscillate the frequencies of the alternating currents applied to the field coils 28.

Preferably, the alternating current applied to the field coils 28 has a frequency selected to match a mechanical resonance frequency of the movable magnet 20. Alternatively, the alternating current applied to the field coils has a range of frequencies that includes the mechanical resonance frequency of the movable magnet. Typically the resonant frequency and operating frequency will be in the range of about 10-200 Hertz. Resonant operation will tend to increase the amplitude of the vibrations produced by the movable magnet, and increase the energy efficiency and force output of the vibrator. The proper resonant frequency for the alternating current can be provided by a feedback control scheme employing the pickup coil 29. The movable magnet induces a current in the pickup coil 29, which is detected by a sensor and used to control the alternating current flowing in the field coils 28. Alternatively, the frequency of the alternating current can be fixed to a value matching or close to a known resonant frequency of the movable magnet.

The resonant frequency of the movable magnet 20 depends mainly on the field strength and mass of the movable magnet 20 and the field strength of the bumper magnets 26. Also, as discussed above, air within the enclosure 30 will function as an air spring in embodiments where the air holes 32 are not provided and the movable magnet 20 has a close-tolerance fit inside the enclosure 30. The air spring will tend to increase the resonant frequency of the movable magnet 20.

Also, it is noted that the electromagnetic vibrator can be operated such that it has a flat frequency response. This can be accomplished by feeding back the sensor signal through an electrical control compensator that adjusts the alternating current amplitude to produce a flat response over a broad frequency range. In this case, less power can be provided to the field coils 28 at frequencies near the resonant frequency. With applied power adjusted according to operating frequency, the present vibrator can have a relatively flat frequency response and can be used to provide constant-amplitude vibrations over a wide range of frequencies. In other words, the present vibrator can function essentially as a speaker.

Preferably, the movable magnet 20 is heavier than the enclosure and other vibrator components. Minimizing the weight of the enclosure 30 and other components relative to the movable magnet 20 will tend to increase the vibration forces that can be transferred, which is desirable.

The field coils 28 are preferably driven by a squarewave signal. A sinusoidal waveform or triangular waveform or any other waveform can also be used. Pulse width modulated signals can also be used to drive the field coils.

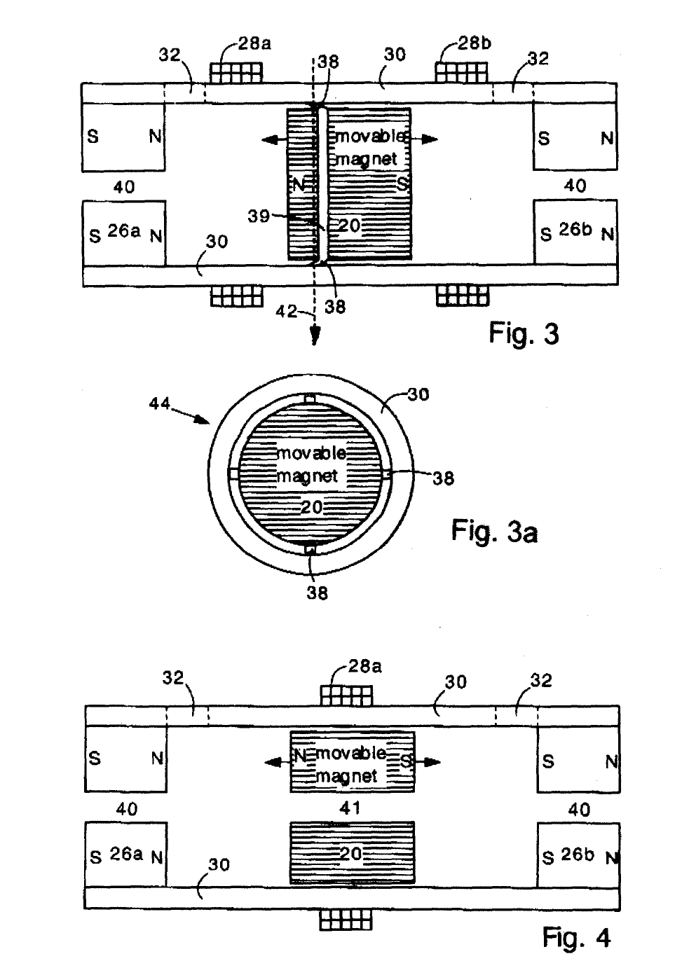

FIG. 3 shows a cross sectional view of an embodiment in which the axial shaft 22 is not present. In this case, the movable magnet can optionally be a solid cylindrical magnet (instead of a toroidal magnet), as shown. Also, in FIG. 3 the bumper magnets 26 are toroidal, with air vents 40. The air vents 40 perform the same function as the air holes 32; the air vents 40 allow air to enter and escape the enclosure 30 as the movable magnet 20 oscillates.

FIG. 3a shows a cross sectional view 44 taken along line 42. The movable magnet 20 has tabs 38 for maintaining the movable magnet 20 in a central position within the enclosure 30. The tabs 38 tend to reduce sliding friction between the movable magnet 20 and the enclosure 30. The tabs 38 can be made of a fluoropolymer (e.g. polytetrafluoroethylene) or other low friction material. Preferably, in embodiments lacking the axial shaft 22, the movable magnet 20 will have 3 or 4 tabs 38 attached. In a preferred implementation, the tabs 38 are peripheral portions of a thin, monolithic disc 39. In this embodiment, the movable magnet 20 can comprise two magnets. The disc 39 will be squeezed between the magnets comprising the movable magnet 20. The disc 39 can have a central hole to accommodate the axial shaft 22 if the shaft 22 is present. Also, the tabs 38 can have a spherical shape so that they make point contact with the enclosure 30. Additionally, the tabs 38 can be replaced with ball bearings.

FIG. 4 shows another embodiment having a single field coil 28a. The single field coil 28a can be operated so that it applies both pushing and pulling forces to the movable magnet 20. Also, the movable magnet 20 of FIG. 4 has an air vent 41 for allowing air to flow past the magnet 20 as it oscillates.

In another embodiment of the present invention, the enclosure 30 is hermetically sealed and evacuated (i.e. the enclosure contains a vacuum or reduced air pressure). In this case, the energy efficiency of the vibrator will tend to be higher due to the reduction of viscous friction from moving air.

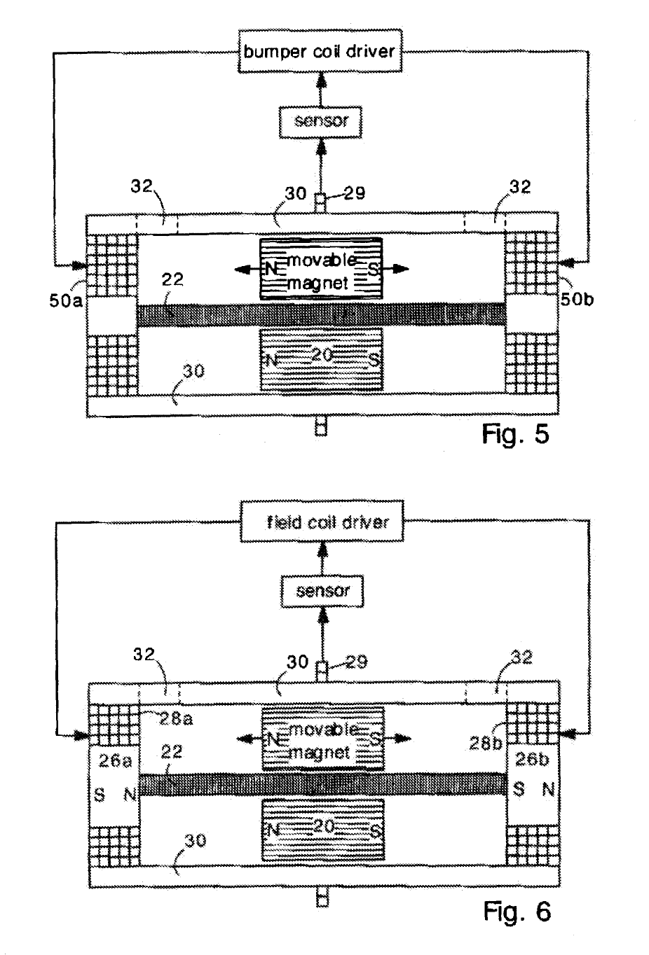

FIG. 5 shows another embodiment having bumper coils 50a 50b. The bumper coils 50 are operated to provide the combined functions of both the field coils 28 and the bumper magnets 26. The bumper coils 50 are operated such that they apply push and pull forces to the movable magnet 20 and cause it to oscillate. Also, the bumper coils 50 are powered when the movable magnet approaches so that the movable magnet is repelled from the field of the bumper coils 50. Consequently, the movable magnet 20 rebounds from the bumper coils 50. The bumper coils are preferably operated in response to signals received from the pickup coil 29, as illustrated in FIG. 5. Also, it is noted that ferromagnetic yokes (not shown) can be used to concentrate the magnetic field from the bumper coils.

FIG. 6 shows another embodiment in which the vibrator has field coils 28a 28b and bumper magnets 26 disposed at the axial ends of the vibrator. In this embodiment, the field coils 28 apply push and pull forces to the movable magnet 20, and the bumper magnets 26 repel the movable magnet. The operation of the vibrator of FIG. 6 is essentially the same as the operation of the vibrator of FIGS. 2 or 3. The movable magnet 20 rebounds from the repelling force of the bumper magnets 26.

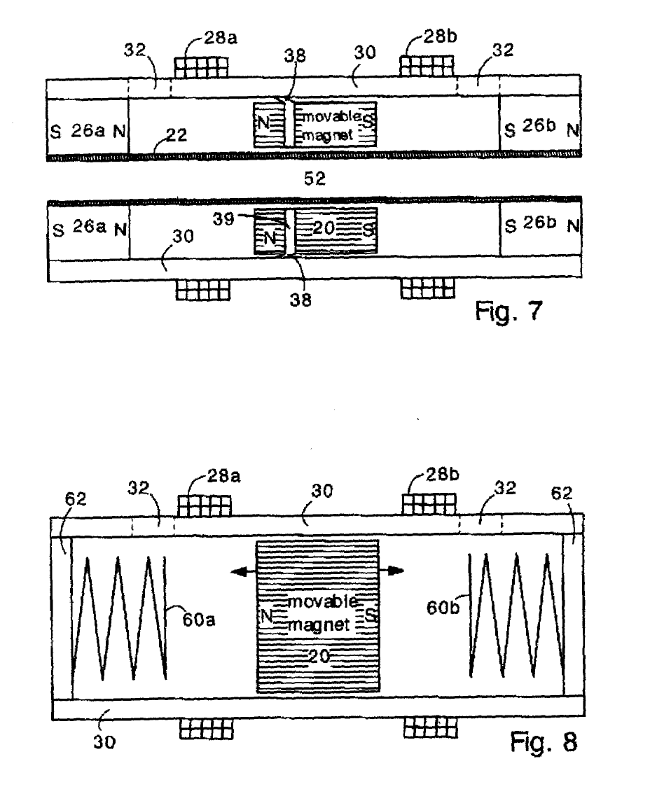

FIG. 7 shows another embodiment in which the axial shaft 22 is hollow (and has hole 52). The hollow shaft extends completely through the entire length of the vibrator. The hole in the shaft 22 can be used for mounting the present vibrator. For example, a bolt, screw or wire can extend through the hole 52 for bolting or otherwise attaching the vibrator to a circuitboard, chassis or other fixture. The vibrator can be attached to objects designed to be vibrated.

FIG. 8 shows another embodiment in which mechanical compression springs 60a 60b are used in place of the bumper magnets 26. The springs 60 can be made of stainless steel, phosphor bronze, resilient plastic or other resilient material. The springs 60 are bonded to end caps 62 of the vibrator. Preferably, the compression springs 60 are nonferromagnetic. In FIG. 8, the repelling force of “bumper magnets” is replaced by the spring force of the springs 60a and 60b. As with the designs discussed above, the moveable magnet is driven towards the end caps 62 by the externally applied electric field. Upon impacting with the springs 60a or 60b, the springs mechanically store energy from the impact and then release the energy to send the moveable magnetic 20 in the opposite direction.

FIG. 9 shows an embodiment in which compression springs 64a 64b are attached to the movable magnet 20. In this embodiment, the compression springs 64 can be ferromagnetic. In operation, the springs 64 cause the movable magnet to rebound after being compressed between the magnet 20 and end cap 62.

The embodiments of FIGS. 8 and 9 can also include an axial shaft 22. In this case, the compression springs 60 64 will be wrapped around and coaxial with the shaft 22.

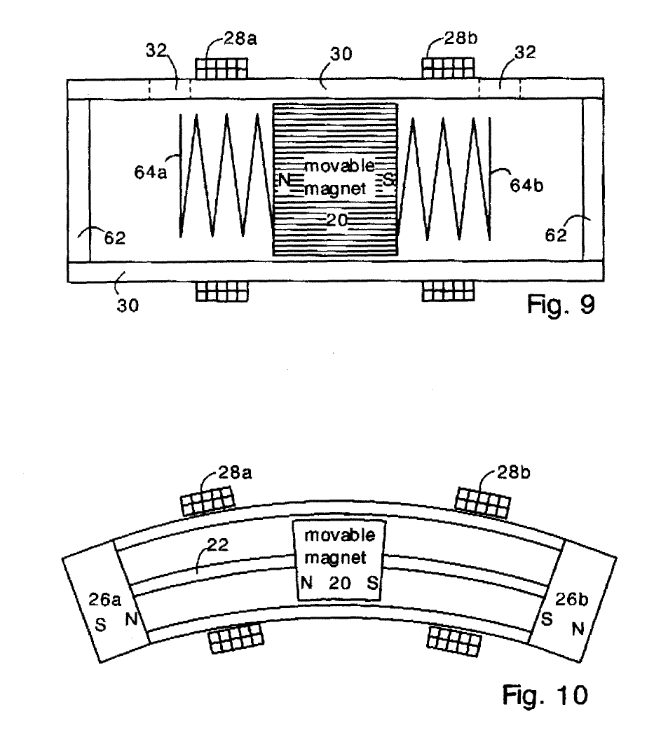

FIG. 10 shows another embodiment of the invention in which the vibrator has a curved shape. The vibrator operates in the same manner as the linear embodiments. Preferably, the shaft 22 is curved. In certain applications, the curved embodiment of FIG. 10 may be preferred. This is because the curved embodiment will produce rotating vibrations in two directions. By comparison, the linear embodiments of FIG. 1-9 will produce linear vibrations in only one direction. Two dimensional vibrations are preferred in applications such as mixing anisotropic heterogeneous materials having properties that vary with direction.

Also, it is noted that the curved embodiment can alternately have compression springs 60 64, pickup coil 29, bumper coils 50, air holes 32 and other features described above.

The present invention provides an energy efficient vibrator useful in many applications. The vibrations produced by the present vibrator can be accurately oriented due to the linear geometry, or planar, curved geometry of the device. Also, the present vibrator can be scaled to very small or very large sizes. For example, the vibrator can be less than ½ or ¼ inch in length. Alternatively, the present vibrator can be 10 or 20 inches in length and produce very powerful vibrations. Also, the present vibrator can produce vibrations over a wide range of frequencies, for example in the range of about 1-3000 hertz.

The present vibrator can be varied in many ways within the scope of the present invention and appended claims. For example, more than one movable magnet can be present in the vibrator. The movable magnet can comprise a single, monolithic magnet, or can comprise two or more magnets bonded or glued together. Also, a non-magnetic mass can be attached to the movable magnet, to increase the mass of the magnet and reduce the resonant frequency of the vibrator. Also, each bumper magnet can comprise multiple magnets or ferromagnetic yokes.

Also, the air holes can be designed to provide an optimum amount of mechanical damping. The present vibrator can be underdamped or overdamped, for example.

It will be clear to one skilled in the art that the above embodiment may be altered in many ways without departing from the scope of the invention. Accordingly, the scope of the invention should be determined by the following claims and their legal equivalents.

1. An electromagnetic vibrator comprising:
a) at least one movable magnet, able to move in an axial direction, wherein the movable magnet is magnetized in the axial direction;
b) two bumper magnets disposed axially in-line with the movable magnet, wherein the bumper magnets are oriented such that they magnetically repel the movable magnet, and wherein the movable magnet is disposed between the bumper magnets; and
c) at least one field coil for causing the movable magnet to move in the axial direction.

2. The electromagnetic vibrator of claim 1, further comprising at least one axial shaft, wherein the movable magnet has a toroidal shape with a hole, and the at least one axial shaft extends through the hole in the movable magnet.

3. The electromagnetic vibrator of claim 2, wherein the at least one axial shaft is hollow and extends between said two bumper magnets.

4. The electromagnetic vibrator of claim 1, further comprising a hollow enclosure, wherein the movable magnet is disposed inside the hollow enclosure, and the at least one field coil is disposed outside the enclosure.

5. The electromagnetic vibrator of claim 4, wherein the hollow enclosure has at least one air hole.

6. The electromagnetic vibrator of claim 1, wherein the bumper magnets or end caps associated with said bumper magnets have air vents.

7. The electromagnetic vibrator of claim 1, wherein the vibrator has at least two spaced apart field coils.

8. The electromagnetic vibrator of claim 7, further comprising:
a pickup coil disposed between the at least two spaced apart field coils, and
a field coil driver circuit for driving the at least two spaced apart field coils in response to signals from the pickup coil.

9. The electromagnetic vibrator of claim 1, wherein the at least one movable magnet moves along a pathway that has a curved shape.

10. The electromagnetic vibrator of claim 1, wherein the movable magnet has a toroidal shape with a hole that permits air flow in an axial direction.

11. An electromagnetic vibrator comprising:
a) at least one movable magnet, able to move in an axial direction, wherein the movable magnet is magnetized in the axial direction;
b) two coils for causing the movable magnet to move in the axial direction, wherein the movable magnet is disposed between the coils.

12. The electromagnetic vibrator of claim 11, further comprising at least one axial shaft, wherein the movable magnet has a toroidal shape with a hole, and the at least one axial shaft extends through the hole in the at least one movable magnet.

13. The electromagnetic vibrator of claim 12, wherein the axial shaft is hollow and extends to end caps at the opposite ends of a pathway along which said at least one moveable magnet is moved in said axial direction.

14. The electromagnetic vibrator of claim 11, further comprising a hollow enclosure, wherein the at least one movable magnet is disposed inside the enclosure.

15. The electromagnetic vibrator of claim 14, wherein the hollow enclosure has at least one air hole.

16. The electromagnetic vibrator of claim 11, wherein the ends of the hollow enclosure have air vents.

17. The electromagnetic vibrator of claim 11, further comprising:
a pickup coil,
a coil driver circuit for driving the two coils in response to signals from the pickup coil.

18. The electromagnetic vibrator of claim 11, wherein the at least one movable magnet has a toroidal shape with a hole that permits air flow in an axial direction.

19. An electromagnetic vibrator comprising:
a) at least one movable magnet, able to move in an axial direction, wherein the at least one movable magnet is magnetized in the axial direction;
b) two compression springs disposed axially in-line with the movable magnet, wherein the movable magnet is disposed between the compression springs;
c) at least one field coil for causing the movable magnet to move in the axial direction.

20. The electromagnetic vibrator of claim 19, further comprising an axial shaft, wherein the at least one movable magnet has a toroidal shape with a hole, and the axial shaft extends through the hole in the at least one movable magnet.

21. The electromagnetic vibrator of claim 19, further comprising a hollow enclosure, wherein the movable magnet is disposed inside the hollow enclosure, and the at least one field coil is disposed outside the hollow enclosure.

22. The electromagnetic vibrator of claim 19, wherein the vibrator has at least two spaced apart field coils.

23. The electromagnetic vibrator of claim 22, further comprising:
a pickup coil disposed between the two spaced apart field coils, and
a field coil driver circuit for driving the two spaced apart field coils in response to signals from the pickup coil.

24. The electromagnetic vibrator of claim 19, wherein the movable magnet has a toroidal shape with a hole that permits air flow in an axial direction.
